(19) United States
(12) Patent Application Publication
(10) Pub. No.: US 2013/0279659 A1
(43) Pub. Date: Oct. 24, 2013

(54) METHOD AND A SYSTEM FOR IMAGE INTEGRATION USING CONSTRAINED OPTIMIZATION FOR PHASE CONTRAST IMAGING WITH AN ARRAGEMENT OF GRATINGS

(71) Applicants: Marco Stampanoni, Endingen (CH); Thomas Thüring, Villigen (CH)

(72) Inventors: Marco Stampanoni, Endingen (CH); Thomas Thüring, Villigen (CH)

(21) Appl. No.: 13/993,769

(22) PCT Filed: Dec. 9, 2011
(86) PCT No.: PCT/EP2011/072332

§ 371 Date: Jul. 9, 2013

(30) Foreign Application Priority Data
Dec. 13, 2010 (EP) 10194726.5

(51) Int. Cl. G06T 7/00; G01N 23/04

(52) U.S. Cl. CPC G06T 7/00; G01N 23/04
USPC 378/62; 382/276

(57) ABSTRACT

High-quality, artifact-free phase contrast images from an object are yielded using an arrangement of gratings. The method suppresses the need of direct image integration and significantly improves the quality of phase contrast images. In comparison with existing techniques, no additional alignment work is needed, nor increased exposure time. On the other hand, the method delivers excellent, direct interpretable information about the phase projection within a radiographic experiment. Due to its general applicability and its simplicity in usage, the method is likely to become a standard method for a variety of 2D imaging applications using gratings arrangements in particular on medical scanners (for instance mammography), inspection at industrial production lines, non-destructive testing, and homeland security.

The present invention relates to a method and a system for the recovery of an integrated image from a differential image by using constrained optimization.

It is well known that, differently from conventional visible light optics, the refractive index in X-ray optics is very close to and smaller than unity. In first approximation, for small and negligible anisotropy in the medium, the index of refraction characterizing the optical properties of a tissue can be expressed—including X-ray absorption—with its complex form: n=1−δ−iβ where δ is the decrement of the real part of the refractive index, characterizing the phase shifting property, while the imaginary part β describes the absorption property of the sample. In conventional absorption-based radiography, the X-ray phase shift information is usually not directly utilized for image reconstruction. However, at photon energies greater than 10 keV and for light materials (made up of low-Z elements), the phase shift term plays a more prominent role than the attenuation term because δ is typically three orders of magnitude larger than β. As a consequence, phase-contrast modalities can generate significantly greater image contrast compared to conventional, absorption-based imaging.

Furthermore, far from absorption edges, δ is inversely proportional to the square of the X-ray energy whilst β decreases as the fourth power of energy. A significant consequence of this mechanism is that phase signals can be obtained with much lower dose deposition than absorption, a very important issue when radiation damage has to be taken into account such as in biological samples or in living systems.

Several approaches have been developed in order to record the phase signal. They can be classified as interferometric methods (with crystals), phase propagation methods, techniques based on an analyzer crystal, or on x-ray gratings. The described invention is in particular in context with the latter technique.

Grating based x-ray imaging setups essentially detect the deflections of x-rays in the object. Such deflections can be either caused by refraction on phase shift gradients in the object resulting in differential phase contrast (DPC) or by scattering on in-homogeneities in the sample resulting in the so-called dark-field image (DFI) contrast. The DPC image signal can be used to obtain phase contrast (PC) images by image processing routines.

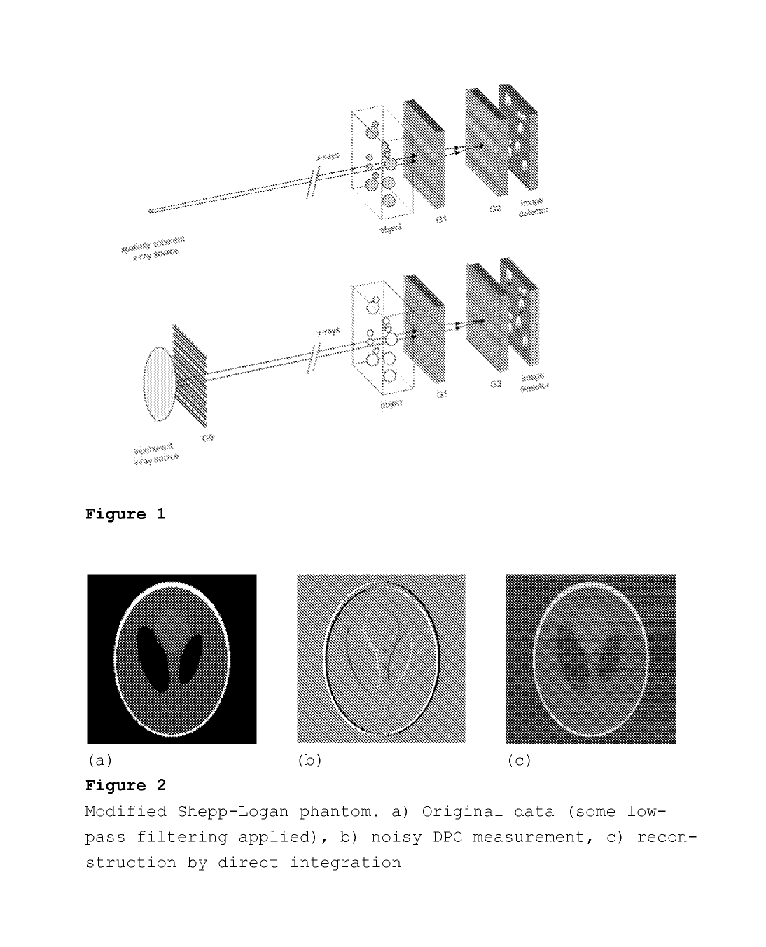

As shown in FIG. 1, set-ups with two gratings (G1 and G2) or three gratings (G0, G1, and G2) can be applied to record the deflection of the x-rays. In the case of a two-grating set-up, the source needs to fulfill certain requirements regarding its spatial coherence, while in a three grating setup no spatial coherence is required. A G0 grating is required, when the source size is bigger than p2*l/d, where p2 is the period of G2, 1 is the distance between the source and G1, and d is the distance between G1 and G2. Therefore, the three grating set-up is suited for use with incoherent x-ray sources, in particular with x-ray tubes.

To separate the conventional attenuation contrast (AC) from the DPC and DFI contrast, a phase-stepping approach is applied. One of the gratings is displaced transversely to the incident beam whilst acquiring multiple images. The intensity signal at each pixel in the detector plane oscillates as a function of the displacement. The average value of the oscillation represents the attenuation contrast (AC). The phase of the oscillation can be directly linked to the first derivative of the wave-front phase profile and thus to the DPC signal. The amplitude of the oscillation depends on the scattering of x-rays in the object and thus yields the DFI signal.

For the (two or three) gratings, several approaches have been proposed and applied. The grating G0 (if required) is the one closest to the source. It usually consists of a transmission grating of absorbing lines with the period p0. It can be replaced by a source that emits radiation only from lines with the same period. The grating G1 is placed further downstream of the source. It consists of lines with a period p1. The grating G2 is the one most downstream of the setup. It usually consists of a transmission grating of absorbing lines with the period p2. It can be alternatively replaced by a detector system that has a grating-like sensitivity with the same period.

Two regimes of setups can be distinguished: in the so called “near field regime” and the “Talbot regime”. In the “near field regime”, the grating period p, grating distances d and the x-ray wavelength λ are chosen such, that diffraction effects are negligible. In this case, all gratings need to consist of absorbing lines. In the “Talbot regime”, diffraction on the grating structures is significant. A sharp distinction between the two regimes is not easily given, as the exact criterion depends on the duty cycle of the grating structure, and whether the gratings are absorbing or phase shifting. E.g., for a grating with absorbing lines and a duty cycle of 0.5, the condition for the “near field regime” is d≧p²/2λ. Here, G1 should consist of grating lines that are either absorbing or, preferentially, phase shifting. Several amounts of phase shift are possible, preferentially π/2 or multiples thereof. The grating periods must be matched to the relative distances between the gratings. In case of setups in the “Talbot regime” the Talbot effect needs to be taken into account to obtain good contrast. The formulae for the grating periods and distances are known in the prior art.

The sample is mostly placed between G0 of G1 (or upstream of G1 in case of a two-grating set-up), however it can be advantageous to place it between G1 and G2.

The presented invention is relevant in all of the abovementioned cases, i.e. in the two- and three-grating case, in the case of the “nearfield regime” and the “Talbot regime”, and for the sample placed upstream or downstream of G1.

In addition, the invention presented here also works in combination with scanning-based systems, for parallel and quasi parallel geometries using planar gratings or for compact fan-beam or cone-beam geometries using cylindrically or spherically curved gratings.

An imaging experiment with the abovementioned system is sensitive to X-ray refraction. The relation between the refractive angle α (relative to the optical axis) and the differential phase shift measured with the system is given by:

$$Δϕ ( x ) = \frac{2 π d}{{p}_{2}} α ( x ) , \qquad ( 1 )$$

where d is the inter-grating distance and p₂ is the period of G2. The x-axis corresponds to the phase stepping direction. Furthermore, the relationship between α(x) and the phase profile φ(x) of the wave after the sample is given by [12]:

$$α ( x ) = \frac{λ}{2 π} \frac{\partial φ ( x )}{\partial x} . \qquad ( 2 )$$

Substituting Eq. (2) into Eq. (1) leads to

$$Δϕ ( x ) = \frac{λ d}{{p}_{2}} \frac{\partial φ ( x )}{\partial x} . \qquad ( 3 )$$

Therefore, Δφ is proportional to the first derivative of φ(x). According to this equation, the reconstruction of φ(x) requires an integration of the DPC measurement in x direction,

$$φ ( x ) = \frac{{p}_{2}}{λ d} \int Δϕ ( x ) d x . \qquad ( 4 )$$

In general, the integration of a noisy signal accumulates the noise errors and the noise variance. As a result, horizontal stripe artifacts with increasing amplitudes in the direction of integration appear. FIG. 2 shows the integration of a noisy DPC image, generated from a modified SheppLogan phantom, where in FIG. 2c, the stripe artifact are clearly visible.

It is therefore an objective of the present invention to provide a system and the method to improve the quality of the integrated phase contrast image.

This objective is achieved according to the present invention by the features of the independent claims 1 and 19. Preferred embodiments of the present invention are given in the dependent claims 2 to 18 and 20 to 36 resp.

The inventive system and the inventive method for the recovery of an integrated image from a differential image by using constrained optimization are comprising:
a) means for identifying an image that minimizes a cost function ∥Tƒ∥ₗ_{ₚ} subject to a constraint ∥W(Dₓƒ−φ)∥ₗ_{₂}, which is written as

minimize ∥T_{f}∥ₗ_{ₚ}

subject to: ∥W(Dₓƒ−φ)|ₗ_{₂}≦ε′
b) wherein f is an image vector, T is a transform operator matrix, Dₓ is a differentiation operator matrix, W a diagnoal matrix containing the reciprocal noise standard deviations, φ is the measured image vector and ε a boundary for the noise power. ∥ . . . ∥ₗ_{ₚ} indicates the p-norm of a vector, where p is a positive number, preferably an integer in the interval [0,2].

A preferred embodiment of the present invention is achieved when the differential image is obtained from an arrangement for x-rays, in particular hard x-rays, for obtaining quantitative x-ray images from a sample comprising:
a. an X-ray source;
b. three or at least two gratings dubbed G0, G1 and G2 or G1 and G2 resp.;
c. a position-sensitive detector with spatially modulated detection sensitivity having a number of individual pixels;
d. means for recording the images of the detector;
e. means for evaluating the intensities for each pixel in a series of images in order to identify the characteristic of the object for each individual pixel as an absorption dominated pixel and/or a differential phase contrast dominated pixel and/or an x-ray scattering dominated pixel;
f. wherein the series of images is collected by continuously or stepwise rotating from 0 to π or 2π either the sample or the arrangement and the source relative to the sample.

Preferably, the system and the method can be operated either in the so-called “near field regime” or in the “Talbotregime”.

A preferred embodiment for the grating G1 provides for G1 as a line grating being either an absorption grating or a phase grating, wherein the phase grating is a low absorption grating but generating a considerable X-ray phase shift, the latter preferably of n/2 or multiples thereof.

Accordingly, the grating G2 can be realized as a line grating having a high X-ray absorption contrast with its period being the same as that of the self image of G1; G2 being placed in front of the detector with its lines parallel to those of G1.

The system and the method allow for a certain freedom of operation where an operation can be chosen to be either in parallel-beam, quasi parallel, fan-beam or cone-beam mode and G0, G1 and G2 have a corresponding planar, cylindrical or spherical shape resp. Accordingly, the operation can be chosen to be either in fullfield mode with two dimensional gratings or in scanning mode with one dimensional gratings.

For the setup of the system and the method, both types of operation can be defined as follows: a) for near-field-regime operation, the distance between the gratings is chosen freely within the regime, and b) for the Talbot-regime is chosen according to

$${D}_{n , sph} = \frac{L \cdot {D}_{n}}{L - {D}_{n}} = \frac{L \cdot n \cdot {p}_{1}^{2} \text{/} 2 {η}^{2} λ}{L - n \cdot {p}_{1}^{2} \text{/} 2 {η}^{2} λ}$$

where n=1, 3, 5, and

$$η = \{ \begin{matrix}1 & if the phase shift of {G}_{1} is ( 2 l - 1 ) \frac{π}{2} , & {p}_{2} = \frac{L + {D}_{n , sph}}{L} {p}_{1} \\ 2 & if the phase shift of {G}_{1} is ( 2 l - 1 ) π , & {p}_{2} = \frac{L + {D}_{n , sph}}{L} \frac{{p}_{1}}{2}\end{matrix} ,$$

where l=1, 2, 3, Dₙ is an odd fractional Talbot distance when the parallel X-ray beam is used, while D_{n,sph} is that when the fan or cone X-ray beam is used, L is the distance between the source and the G1.

In order to benefit from the full advantages of the differential phase contrast approach, the system and the method are executed in a way that the phase stepping is performed by mechanical shift of one grating G0, G1 or G2 with respect to the others.

With respect to the grating structure, the grating structure may be advantageously manufactured by planar technology.

In order to separate the differential phase information in the image, such as a medical image from a CT, MRI or ultrasonic facility, the differential phase information may be obtained according to the European Patent application EP 10167569.2 which is herewith incorporated by reference.

In a further preferred embodiment of the present invention, the phase relation between G1 and G2 can correspond exactly to the value for which the intensity curve can be expanded by a first order Taylor series and the differential phase information can be obtained preferably according to the International Patent application PCT/EP2010/051291 (WO 2010/089319) which is herewith incorporated by reference.

During the solution of the mathematical cost function, the operator Dₓ may be designed as a differentiation operator of any order in the phase stepping direction of the gratings. Accordingly, the transform operator T may be chosen to be a differentiation operator of any order in the direction perpendicular to the stepping direction of the gratings. Further, the weighting operator W may be chosen to be a diagonal weighting matrix containing the inverse standard deviation 1/σ_{DPC} of the DPC image in each pixel.

Preferably, the constrained optimization problem can be solved by recasting it to a second order cone program (SOCP). Alternatively, the constrained optimization problem may be solved by casting it to an unconstrained form possibly according to:

$$minimize \vert \vert W ( {D}_{x} f - ϕ ) {\vert \vert}_{{l}_{2}}^{2} + {Σ}_{i} {λ}_{i} \vert \vert {T}_{i} f {\vert \vert}_{{l}_{{p}_{1}}}^{{p}_{1}}$$

Alternatively, the unconstrained optimization problem may be solved by means of a Gradient descent or a (non-linear) Conjugate Gradient algorithm.

Thereby, the new invention addresses the problem of stripe artifacts upon direct integration of noisy DPC images. The fundamental idea is to suppress the variations in the vertical image direction by solving a constrained optimization problem. While maintaining consistency with the measured data, the phase image is retrieved by minimizing a cost function. Applied to the case of noisy DPC measurements, this forces the integration to generate lower variations in the image and therefore improve image quality.

Preferred example of the present invention are described hereinafter in more detail.

Hereafter, images, such as medical images or images from structure analysis or material testing and the like, are represented as vectors. An image vector f(i) is obtained from the column-wise extraction of pixel values in an image I(x,y)

$$f ( i ) = I ( ⌊ \frac{i}{{n}_{y}} ⌋ , i mod {n}_{y} ) \qquad ( 5 )$$

where nₓ×n_{y} is the image size. The size of an image vector is 1×n with n=nₓ·n_{y}. Image transformations are represented by operators (matrices) which can be applied to an image vector. Operator matrices are of the size m×n, where m is the size of the transformed vector. In most cases, m=n holds.

The new method is based on a standard linear regression model, where the measurement of the DPC image is given by

φ=Dₓ·φ+w. (6)

Dₓ is the measurement operator modelling the differential measurement of φ and w is a random vector modelling the noise in a DPC image. Dₓ can be implemented with a finite difference transform of φ in x-direction.

Regarding the noise model, the noise variance in a pixel of a DPC image is given by

$${σ}_{DPC}^{2} ∝ \frac{1}{{NV}^{2}} , \qquad ( 7 )$$

where N is the number of photons and V is the mean fringe visibility at this pixel. N and V can be calculated by using the AC and DFI images of the measurement.

For the phase retrieval from a DPC measurement, a constrained optimization problem is defined:

minimize ∥Tθ∥ₗ_{ₚ}

subject to: |W(Dₓƒ−φ)∥ₗ_{₂}≦ε (8)

In this optimization problem, f is an image vector, T is a transform operator, φ is the measured DPC image vector and ε is a boundary for the noise power. W is a diagonal weighting matrix for taking into account the noise model, with w_{i,i}=1/σ_{DPC,i}·∥ . . . ∥ₗ_{ₚ} indicates a p-norm of a vector, which is defined as

$$\vert \vert x {\vert \vert}_{{l}_{p}} = {( {Σ}_{i} \vert {x}_{i} {\vert}^{p} )}^{1 \text{/} p} . \qquad ( 9 )$$

The problem expressed in (8) seeks for the minimal p-norm of the vector Tf for any f which meets the data consistency constraint ∥W(Dₓƒ−φ)∥ₗ_{₂}<ε.

In the minimization term of (8), the image can be trans-formed into any linear transform domain represented by the matrix T (e.g. Fourier transform, wavelet, finite differences, etc.). This makes the utilization of data constraints extremely flexible. In the case of DPC measurements, a finite differences transform

T=D_{y}, (10)

is preferable, because the integrated image is distorted by high intensity variations (horizontal stripes) in the direction perpendicular to phase stepping.

There is a variety of possibilities to solve problem (8). In the convex case (p≧1), it can be recasted and solved as a second order cone program. An alternative is to recast (8) to an unconstrained form using a Lagrange multiplier,

minimize ∥W(Dₓƒ−φ∥ₗ_{₂}²+λ∥Tƒ∥ₗ_{ₚ}^{p}, (11)

or in general, with an arbitrary amount of data constraints,

$$minimize \vert \vert W ( {D}_{x} f - ϕ ) {\vert \vert}_{{l}_{2}}^{2} + {Σ}_{i} {λ}_{i} \vert \vert {T}_{i} f {\vert \vert}_{{l}_{{p}_{1}}}^{{p}_{1}} \qquad ( 12 )$$

This problem formulation is also known as regularization, which has mainly been applied for the inversion of ill-posed problems. The Lagrangian multiplier (or regularization parameter) λᵢ controls the weighting of the regularization term ∥Tᵢƒ∥ₗ_{ₚᵢ}^{p}^{ᵢ} compared to the data consistency term ∥W(Dₓƒ−φ)ₗ_{₂}². Problem (12) has the powerful property to allow any number of regularization terms, which is particularly useful if more a-priori knowledge about the object is available.

The choice of the norm parameter p in the regularization term depends on the used transform operator T. A typical choice is p=2, since in this case, problems (11)/(12) are linear and an explicit solution exists. For the case T=D_{y}, the l₂-norm can lead to blurring and therefore reduce image resolution. On the other hand, the minimization of the l₁-norm (p=1) is well known to preserve edges in the image and is thus expected to yield a better image resolution than the l₂-norm [1]. An l₁-norm minimization leads to a non-linear optimization problem where no explicit solution exists.

Here, an iterative algorithm is used to solve the non-linear optimization problem. It is based on a non-linear Conjugate Gradients (NLCG) method, which is characterized by a fast convergence for the inversion of large-scale linear systems [2].

### REFERENCES

[1] L. Rudin, S. Osher, and E. Fatemi, “Nonlinear total variation based noise removal algorithms,” Phys. D Nonlinear Phenom. 60, 259?268 (1992)
[2] J. Nocedal and S. Wright, Numerical optimization (Springer verlag, 1999)

1-36. (canceled)

37. A method for the recovery of an integrated image from a differential image by using constrained optimization, the method which comprises the following steps:
identifying an image that minimizes a cost function ∥Tƒ∥₁_{ₚ} subject to a constraint ∥W(Dₓƒ−φ)∥ₗ_{₂}, which is written as
minimize |Tƒ∥lₚ
subject to: ∥W(Dₓf−φ)∥₁_{₂}≦ε
where f is an image vector, T is a transform operator matrix, Dₓ is a differentiation operator matrix, W a diagonal matrix containing the reciprocal noise standard deviations, φ is the measured image vector and ε is a boundary for the noise power; and
where ∥ . . . ∥lₚ indicates a p-norm of a vector, where p is a positive number with a preferred value being an integer in the interval [0,2].

38. The method according to claim 37, wherein the differential image data are obtained from an arrangement for x-rays (e.g., hard x-rays) for obtaining quantitative x-ray images from a sample, the arrangement comprising:
a. an X-ray source;
b. three or at least two gratings dubbed G0, G1 and G2 or G1 and G2;
c. a position-sensitive detector with spatially modulated detection sensitivity having a number of individual pixels;
d. recordation means for recording the images of the detector;
e. evaluation means for evaluating the intensities for each pixel in a series of images in order to identify a characteristic of the object for each individual pixel as an absorption dominated pixel and/or a differential phase contrast dominated pixel and/or an x-ray scattering dominated pixel;
f. wherein the series of images is collected by continuously or stepwise rotating from 0 to π or 2 π one of the sample or the arrangement relative to the other.

39. The method according to claim 38, which comprises operating the arrangement either in the “near field regime” or in the “Talbot-regime.”

40. The method according to claim 38, wherein G1 is a line grating either an absorption grating or a phase grating, that is a low absorption grating but generating a considerable X-ray phase shift, the latter preferably of π/2 or multiples thereof.

41. The method according to claim 38, wherein G2 is a line grating having a high X-ray absorption contrast with a period thereof being the same as that of a self image of G1, and G2 is placed in front of the detector with lines of the grating G2 being parallel to the lines of the G1 grating.

42. The method according to claim 38, which comprises operating the arrangement either in parallel-beam, quasi parallel, fan-beam or cone-beam mode and G0, G1 and G2 have a corresponding planar, cylindrical or spherical shape, respectively.

43. The method according to claim 37, which comprises choosing an operation to be either in full-field mode with two-dimensional gratings or in scanning mode with one-dimensional gratings.

44. The method according to claim 37, wherein for near-filed-regime operation, the distance between the gratings is chosen freely within the regime, and for the Talbot-regime the distance between the gratings is chosen according to
$${D}_{n , sph} = \frac{L \cdot {D}_{n}}{L - {D}_{n}} = \frac{L \cdot n \cdot {p}_{1}^{2} \text{/} 2 {η}^{2} λ}{L - n \cdot {p}_{1}^{2} \text{/} 2 {η}_{2} λ}$$
where n=1, 3, 5, and
$$η = \{ \begin{matrix}1 & if the phase shift of {G}_{1} is ( 2 l - 1 ) \frac{π}{2} , & {p}_{2} = \frac{L + {D}_{n , sph}}{L} {p}_{1} \\ 2 & if the phase shift of {G}_{1} is ( 2 l - 1 ) π , & {p}_{2} = \frac{L + {D}_{n , sph}}{L} \frac{{p}_{1}}{2}\end{matrix} ,$$
where l=1, 2, 3, Dₙ is an odd fractional Talbot distance when the parallel X-ray beam is used, while D_{n,sph} is that when the fan or cone x-ray beam is used, L is the distance between the source and the G1

45. The method according to claim 38, which comprises performing a phase stepping by mechanically shifting one grating G0, G1 or G2 with respect to the other gratings.

46. The method according to claim 37, wherein the grating structure is manufactured by planar technology.

47. The method according to claim 37, which comprises acquiring the differential phase information according to the European Patent application EP 10167569.2.

48. The method according to claim 37, wherein the phase relation between G1 and G2 corresponds exactly to a value for which an intensity curve can be expanded by a first order Taylor series and the differential phase information is obtained according to Patent Application Publication Pub. No.: US 2012/0041679 A1 (WO 2010/089319).

49. The method according to claim 37, wherein the operator Dₓ is a differentiation operator of any order in the phase stepping direction of the gratings.

50. The method according to claim 37, wherein the transform operator T is a differentiation operator of any order in the direction perpendicular to the stepping direction of the gratings.

51. The method according to claim 37, wherein the weighting operator W is a diagonal weighting matrix containing the inverse standard deviation 1/σ_{DPC} of the DPC image in each pixel.

52. The method according to claim 37, which comprises solving a constrained optimization problem by recasting same to a second order cone program.

53. The method according to claim 37, which comprises solving a constrained optimization problem by casting same to an unconstrained form according to:
minimize ∥W(Dₓƒ−φ∥ₗ_{₂}²+Σᵢλᵢ∥Tᵢƒ∥ₗ_{ₚᵢ}^{p}^{ᵢ}.

54. The method according to claim 37, which comprises solving a unconstrained optimization problem by way of a Gradient descent or a (non-linear) Conjugate Gradient algorithm.

55. A system for the recovery of an integrated image from a differential image by using constrained optimization, the system comprising:
a) means for identifying an image that minimizes a cost function ∥Tƒ∥ₗ_{ₚ} subject to a constraint ∥W(Dₓƒ−φ∥ₗ_{₂}, which is written as
minimize ∥Tƒ∥ₗ_{ₚ},
subject to: ∥W(Dₓƒ−φ∥ₗ_{₂}≦ε′,
b) wherein f is an image vector, T is a transform operator matrix, Dₓ is a differentiation operator matrix, W a diagonal matrix containing the reciprocal noise standard deviations, φ is the measured image vector and ε a boundary for the noise power. ∥ . . . ∥ₗ_{ₚ} indicates the p-norm of a vector, where p is a positive number with a preferred integer value in the interval [0,2].

56. The system according to claim 55, where the differential image is obtained from an arrangement for x-rays (in particular hard x-rays), for obtaining quantitative x-ray images from a sample comprising:
a. an X-ray source;
b. three or at least two gratings dubbed G0, G1 and G2 or G1 and G2 respectively;
c. a position-sensitive detector with spatially modulated detection sensitivity having a number of individual pixels;
d. recordation means for recording the images of the detector;
e. evaluation means for evaluating the intensities for each pixel in a series of images in order to identify the characteristic of the object for each individual pixel as an absorption dominated pixel and/or a differential phase contrast dominated pixel and/or an x-ray scattering dominated pixel;
f. wherein the series of images is collected by continuously or stepwise rotating from 0 to π or 2π one of the sample or the arrangement relative to the other.

57. The system according to claim 55, configured for being operated either in the “near field regime” or in the “Talbot-regime”.

58. The system according to claim 56, wherein G1 is a line grating being either an absorption grating or a phase grating, wherein the phase grating is a low absorption grating but generating a considerable X-ray phase shift, with a preferred phase shift being a π/2 shift or multiples thereof.

59. The system according to claim 56, wherein G2 is a line grating having a high X-ray absorption contrast with its period being the same as that of the self image of G1; G2 being placed in front of the detector with lines of the grating G2 parallel to the lines of the grating G1.

60. The system according to claim 56, wherein an operation is chosen to be either in parallel-beam, quasi parallel, fan-beam or cone-beam mode and G0, G1 and G2 have a corresponding planar, cylindrical or spherical shape respectively.

61. The system according to claim 55, wherein an operation is chosen to be either in fullfield mode with two dimensional gratings or in scanning mode with one dimensional gratings.

62. The system according to claim 55, wherein for near-field-regime operation, the distance between the gratings is chosen freely within the regime, and for the Talbot-regime is chosen according to
$${D}_{n , sph} = \frac{L \cdot {D}_{n}}{L - {D}_{n}} = \frac{L \cdot n \cdot {p}_{1}^{2} \text{/} 2 {η}^{2} λ}{L - n \cdot {p}_{1}^{2} \text{/} 2 {η}_{2} λ}$$
where n=1, 3, 5, and
$$η = \{ \begin{matrix}1 & if the phase shift of {G}_{1} is ( 2 l - 1 ) \frac{π}{2} , & {p}_{2} = \frac{L + {D}_{n , sph}}{L} {p}_{1} \\ 2 & if the phase shift of {G}_{1} is ( 2 l - 1 ) π , & {p}_{2} = \frac{L + {D}_{n , sph}}{L} \frac{{p}_{1}}{2}\end{matrix} ,$$
where l=1, 2, 3 . . . , Dₙ is an odd fractional Talbot distance when the parallel X-ray beam is used, while D_{n,sph} is that when the fan or cone X-ray beam is used, L is a distance between the source and a line grating G1.

63. The system according to claim 56, wherein phase stepping is performed by mechanical shift of one grating G0, G1 or G2 with respect to the other gratings.

64. The system according to claim 56, wherein said gratings have a grating structure manufactured by planar technology.

65. The system according to claim 55, wherein the differential phase information is obtained according to the European Patent application EP 10167569.2.

66. The system according to claim 55, wherein a phase relation between the gratings G1 and G2 corresponds exactly to a value for which an intensity curve can be expanded by a first order Taylor series and the differential phase information is obtained according to Patent Application Publication Pub. No.: US 2012/0041679 A1 (WO 2010/089319).

67. The system according to claim 55, wherein the operator Dₓ is a differentiation operator of any order in a phase stepping direction of the gratings.

68. The system according to claim 55, wherein the transform operator T is a differentiation operator of any order in a direction perpendicular to a stepping direction of the gratings.

69. The system according to claim 55, wherein the weighting operator W is a diagonal weighting matrix containing an inverse standard deviation 1/σDPc of the DPC image in each pixel.

70. The system according to claim 55, wherein a constrained optimization problem is solved by recasting same to a second order cone program.

71. The system according to claim 55, wherein a constrained optimization problem is solved by casting same to an unconstrained form according to:
minimize ∥W(Dₓƒ−φ∥ₗ_{₂}²+Σᵢλᵢ∥Tᵢƒ∥ₗ_{ₚᵢ}^{p}^{ᵢ}.

72. The system according to claim 55, wherein the unconstrained optimization problem is solved by way of a Gradient descent or a (non-linear) Conjugate Gradient algorithm.
